(19) United States
(12) Patent Application Publication
(10) Pub. No.: US 2025/0112238 A1
(43) Pub. Date: Apr. 3, 2025

(54) IMPROVED ELECTRODE MATERIAL FOR PRINTING ORGANIC POLYMER BATTERIES

(71) Applicant: EVONIK OPERATIONS GMBH, Essen (DE)

(72) Inventors: Andreas WILD, Haltern am See (DE); Lina HÄHNEL, Duisburg (DE); Sébastien COCHET, Ratingen (DE)

(73) Assignee: InnovationLab GmbH, Heidelberg (DE)

(21) Appl. No.: 18/715,265

(22) PCT Filed: Dec. 2, 2021
(86) PCT No.: PCT/EP2021/083885

§ 371 Date: Jul. 5, 2024

(51) Int. Cl. H01M 4/60; H01M 4/02; H01M 4/62; H01M 10/04

(52) U.S. Cl. CPC H01M 4/604; H01M 2004/027; H01M 4/621; H01M 10/0427

(57) ABSTRACT

An electrode material includes at least one organic redox-active polymer P_{Redox}, at least one conductivity additive L, and at least one cellulose ether C. The at least one cellulose ether C acts as a binder. The redox-active polymer P_{Redox} is a polyimide which includes 3,4,9,10-perylene tetracarboxylic acid diimide units. The electrode material makes it possible to manufacture organic batteries having improved charging and discharging capacities. Electrodes include the electrode material and charge storage elements, in particular batteries, that house the electrodes.

The present invention relates to an electrode material comprising at least one organic redox-active polymer P_{Redox}, at least one conductivity additive L and at least one cellulose ether C. The at least one cellulose ether C acts as a binder. The redox-active polymer P_{Redox} is a polyimide which comprises 3,4,9,10-perylene tetracarboxylic acid diimide units.

The electrode material according to the invention makes it possible to manufacture organic batteries having improved charging and discharging capacities. The invention also relates to electrodes comprising the electrode material as well as to charge storage elements, in particular batteries, comprising the electrodes.

### 1. BACKGROUND OF THE INVENTION

Organic batteries are electrochemical cells which use an organic charge storage material as an active electrode material for storing electrical charge. They are developing into an increasingly important alternative to metal-based charge storage materials and differ from these by a fundamentally different mode of action. Lithium-ion batteries as typical representatives of metal-based batteries are used, for example, as standard for storing large amounts of electrical charge (stationary storage devices, e-cars, laptops, etc.), but are usually not suitable for storing smaller amounts of current which are required, for example, for IoT (Internet of Things) applications. For such applications, organic charge storage materials are the electrode material of choice because of their advantageous properties such as weight, processability, sustainability and flexible usability.

The literature describes a large number of organic storage materials. WO 2020/002032 A1 and S. Muench, A. Wild, C. Friebe, B. Hsupler, T. Janoschka, U. S. Schubert, Chem. Rev. 2016, 116, 9438-9484 provide an overview.

Polyimides are an important organic storage material. These are described, for example, in the following literature references:
X. Jiang, Y. Bin, M. Matsuo, Polymer 2005, 46, 7418-7424;
J. Manuel, X. Zhao, K. Cho, J. Kim, J. Ahn, ACS Sustainable Chem. Eng. 2018, 6, 8159-8166;
H. Wang, S. Yuan, D. Ma, X. Huang, F. Meng, X. Zhang, Adv. Energy Mater. 2014, 4, 1301651;
P. Sharma, D. Damien, K. Nagarajan, M. M. Shaijumon, M. Hariharan, J. Phys. Chem. Lett. 2013, 4, 3192-3197;
H. Wu, K. Wang, Y. Meng, K. Lu, Z. Wie, J. Mater. Chem. A 2013, 1, 6366-6372;
WO 2020/182327 A1.

These polyimides are prepared as composites in the presence of conductive materials (carbon such as carbon black or carbon nanotubes, “CNT”) and processed to the electrode by means of organic solvents and binders (most of which are polyvinylidene fluoride, “PVDF” or poly-(vinylidene fluoride-co-hexafluoropropylene, “PVDF-HFP”). Mainly aromatic polyimides are used, since they stand out for advantageous mechanical, chemical and thermooxidative properties and high stability. The basic units in the typical polyimides are derived from pyromellitic acid diimide, 1,4,5,8-naphthalene tetracarboxylic acid diimide and 3,4,9,10-perylene tetracarboxylic acid diimide.

The topic of sustainability plays an increasingly important role in energy storage technology. There is a great interest in the production of environmentally friendly electrodes. One approach is to replace electrode formulations based on organic solvents (most of which are N-methyl-2-pyrrolidone, “NMP”) with water-based alternatives. Since many binder systems, such as those based on fluoropolymers (PVDF and derivatives), are not water-soluble, they are excluded as a component of such water-based electrode formulations and must be replaced by water-soluble binders. An important alternative class of binders are cellulose-based binders, and especially the sodium salts of carboxymethylcellulose (“Na-CMC”), which are available in various degrees of substitution.

However, electrode materials in which cellulose-based binders with polyimides are present as redox-active material often have insufficient capacities. There is thus a need to improve the capacities of electrodes based on organic charge storage material and, in particular, to provide polyimides which, in combination with cellulose-based binders, have high charging and discharging capacities at a higher current intensity and a high cycling resistance.

The object of the present invention was to provide such improved organic charge storage materials.

### 2. BRIEF DESCRIPTION OF THE INVENTION

It has now surprisingly been observed that electrodes which comprise PTCDA-based polyimides as redox-active electrode material have particularly advantageous properties when cellulose ethers are used as binders. It has thus surprisingly been found that these polyimides are particularly suitable as electrode materials for electrodes in the production of which a water-based electrode slurry is used which therefore comprises corresponding water-soluble binder additives such as cellulose ethers.

Compared with other polyimide polymers (e.g., NTCDA-based or PMDA-based), the PTCDA-based polymers surprisingly have a higher charging and discharging capacity at a higher current intensity and a better cycling resistance when combined with cellulose ethers as binders.

The present invention thus relates in a first aspect to an electrode material comprising
(i) at least one organic redox-active polymer P_{Redox},
(ii) at least one conductivity additive L,
(iii) at least one cellulose ether C,
(iv) optionally at least one ionic liquid IL₁,
   characterized in that
   the organic redox-active polymer P_{Redox} is a polyimide which comprises n repeat units of the following structural formula (I):

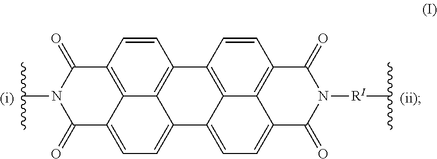

wherein R^{I} is selected from the group consisting of at least two phenylene radicals linked to one another via an oxygen atom, direct bond, carbonyl group, alkylene group, divalent aromatic hydrocarbon group, alkylene group having at least one carbonyl group and/or at least one ether group,
and wherein n is an integer≥2,
and wherein in the structural formula (I) at least one aromatic carbon atom may be substituted by a group selected from alkyl, halogen, alkoxy, OH,
and wherein the bond characterized by “(i)” of a repeat unit of the structural formula (I) bonds to the bond characterized by “(ii)” of the adjacent repeat unit of the structural formula (I),
and the repeat units of the structural formula (I) comprised by the polymer P_{Redox} are identical to or different from one another.

The cellulose ether C is the binder additive in the electrode material according to the first aspect of the invention. In particular, the electrode material according to the first aspect of the invention is an electrode slurry, preferably an aqueous electrode slurry.

In a second aspect, the present invention relates to an electrode comprising the electrode material according to the invention.

In a third aspect, the present invention relates to a charge storage unit comprising at least one electrode according to the invention.

In a fourth aspect, the present invention relates to the use of the electrode material according to the invention as an ink in printing processes.

### 3. FIGURES

FIG. 1 (“FIG. 1”) shows the results of capacitance measurements with cells constructed according to the examples. The figure shows the capacitance of the respective cell after 150 charging and discharging cycles at a charging and discharging rate of 1 C, i.e. full charging and discharging in one hour each. The x-axis of the figure indicates the respective charging cycle, the y-axis the capacitance in mAh g⁻¹.

“●/◯” show the values of the cell with the anode prepared in comparative example V1, which comprises the polyimide PMDA-EDA-Orgacyl with structure 1. “●” shows the value at charging, “◯” shows the value at discharging.

“▴/Δ” show the values of the cell with the anode prepared in comparative example V2, which comprises the polyimide NTCDA-EDA-Orgacyl with structure 2. “▴” shows the value at charging, “Δ” shows the value at discharging.

“▪/□” show the values of the cell with the anode prepared in inventive example E1, which comprises the polyimide PTCDA-EDA-Orgacyl with structure 3. “▪” shows the value at charging, “□” shows the value at discharging.

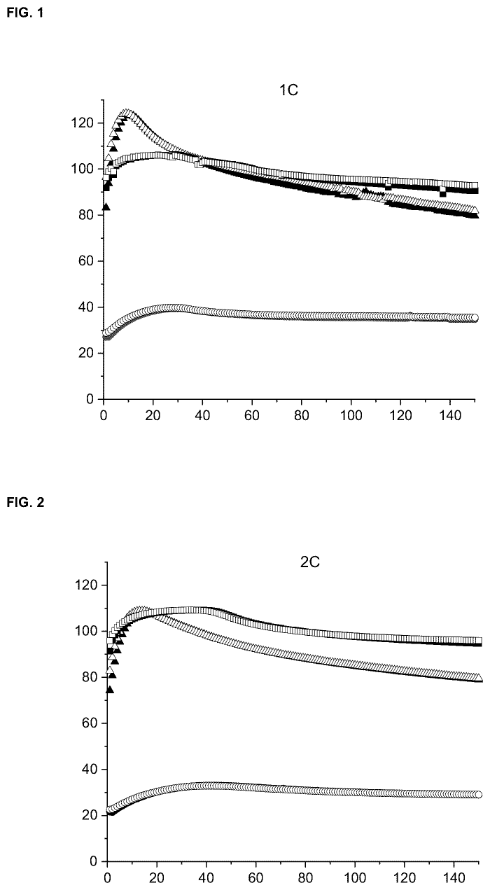

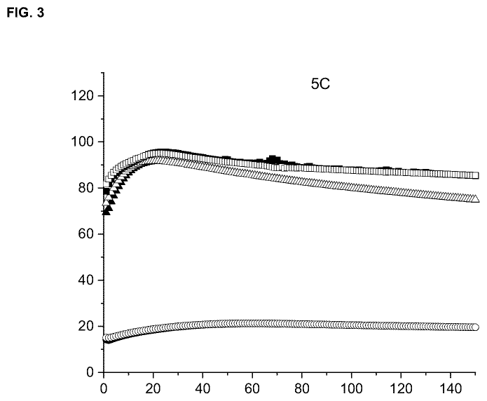

FIG. 2 (“FIG. 2”) shows the results of further capacitance measurements with cells constructed according to the examples. The test series shown in FIG. 2 corresponds to the test series shown in FIG. 1 with the difference that the charging and discharging rate was twice as high, i.e. 2 C, i.e. full charging and discharging in ½ hour each.

FIG. 3 (“FIG. 3”) shows the results of further capacitance measurements with cells constructed according to the examples. The test series shown in FIG. 3 corresponds to the test series shown in FIG. 1 with the difference that the charging and discharging rate was five times as high, i.e. 5 C, i.e. full charging and discharging in 12 minutes each.

### 4. DETAILED DESCRIPTION OF THE INVENTION

### 4.1 Organic Redox-Active Polymer P_{Redox}

The electrode material according to the first aspect of the invention comprises at least one organic redox-active polymer P_{Redox}.

The organic redox-active polymer P_{Redox} is a polyimide which comprises n repeat units of the following structural formula (I):

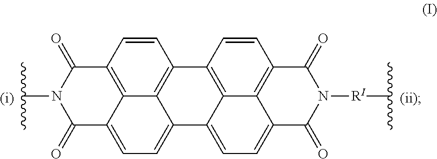

wherein R^{I} is selected from the group consisting of direct bond,
carbonyl group,
alkylene group,
divalent aromatic hydrocarbon group,
alkylene group having at least one carbonyl group and/or at least one ether group,
at least two phenylene radicals linked to one another via an oxygen atom,
and wherein n is an integer≥2, in particular an integer≥4, preferably an integer≥5, more preferably an integer in the range from 5 to 10⁵, even more preferably an integer in the range from 5 to 10⁴, even more preferably an integer in the range from 5 to 10³, most preferably an integer in the range from 5 to 100,
and wherein in the structural formula (I) at least one aromatic carbon atom may be substituted by a group selected from alkyl, halogen, alkoxy, OH,
and wherein the bond characterized by “(i)” of a repeat unit of the structural formula (I) bonds to the bond characterized by “(ii)” of the adjacent repeat unit of the structural formula (I),
and the repeat units of the structural formula (I) comprised by the polymer P_{Redox} are identical to or different from one another.

In particular, R^{I} is selected from the group consisting of a direct bond, a carbonyl group, an alkylene group, a divalent aromatic hydrocarbon group, an alkylene group having at least one carbonyl group and/or at least one ether group, and at least two phenylene radicals linked to one another via an oxygen atom.

Preferably, R^{I} is selected from the group consisting of a direct bond, a carbonyl group, an alkylene group, a divalent aromatic hydrocarbon group, and at least two phenylene radicals linked to one another via an oxygen atom.

More preferably, R^{I} is selected from the group consisting of direct bond, carbonyl group, alkylene group, divalent aromatic hydrocarbon group, and a divalent group of the structure (III).

Even more preferably, R^{I} is selected from the group consisting of a direct bond, a carbonyl group, and an alkylene group having 1 to 10, in particular 1 to 6, preferably 1 to 2, more preferably 2 carbon atoms, phenylene, tolylene, and 4,4′-methylenebis(phenylene).

Even more preferably, R^{I} is selected from the group consisting of a carbonyl group, an alkylene group having 1 to 10, in particular 1 to 6, preferably 1 to 2, more preferably 2 carbon atoms, phenylene, tolylene, and 4,4′-methylenebis(phenylene).

Even more preferably, R^{I} is an alkylene group having 1 to 10, in particular 1 to 6, preferably 1 to 2, more preferably 2 carbon atoms.

Most preferably, R^{I} is a 1,2-ethylene group. Then the repeat unit of the structural formula (I) has the following structure (I)′:

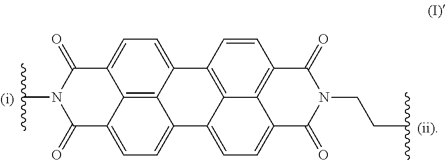

An “alkylene group having at least one ether group” is obtained formally from an alkylene group in which at least one compound between two carbon atoms of the alkylene group is replaced by an oxygen atom. An alkylene group having at least one ether group is, in particular, a group of the structure ( [symbol] )-[C_{q}H_{2q}O]ₚ—C_{q}H_{2q}-(ii) wherein p is an integer from 1 to 50, in particular 1 to 40, preferably 1 to 30, more preferably 1 to 20, even more preferably 1 to 10, even more preferably 1 to 5, even more preferably 1 to 3, most preferably 1 or 2, and wherein q is an integer from 2 to 6, in particular 2 to 5, preferably 2 to 4, more preferably 2 or 3, even more preferably 2 wherein the bond “(ii)” corresponds to the bond (ii) shown in structural formula (I), and the bond “( [symbol] )” corresponds to the other bond, different from (ii), of the radical R^{I}.

An “alkylene group having at least one carbonyl group” is obtained formally from an alkylene group in which at least one compound between two carbon atoms of the alkylene group is replaced by a carbonyl group [“C(═O)”]. In particular, this is a group of the structure ( [symbol] )-(CₛH₂ₛ)—(C═O)—(CₜH₂ₜ)-(ii) wherein s and t are each independently an integer from 1 to 50, in particular 1 to 40, preferably 1 to 30, more preferably 1 to 20, even more preferably 1 to 10, even more preferably 1 to 5, even more preferably 1 to 3, most preferably 1 or 2, and most preferably 1, wherein the bond “(ii)” corresponds to the bond (ii) shown in structural formula (I), and the bond “( [symbol] )” corresponds to the other bond, different from (ii), of the radical R^{I}.

“At least two phenylene radicals linked to one another via an oxygen atom” is, in particular, a divalent group of the following structure (III). The divalent group of the structure (III) is preferably a divalent group of the following structure (III)′:

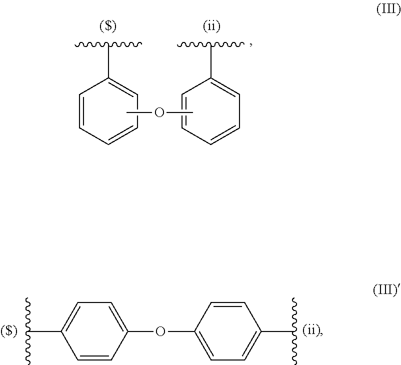

wherein the bond “(ii)” in the structural formulae (III) and (III)′ respectively corresponds to the bond (ii) shown in the structural formula (I), and the bond “($)” in the structural formulae (III) and (III)′ respectively corresponds to the other bond, different from (ii), of the radical R^{I} in the structural formula (I).

In the structural formula (I) at least one aromatic carbon atom may be substituted by a group selected from alkyl, halogen, alkoxy, OH. This means that a substitution by a group selected from alkyl, halogen, alkoxy, OH may be present on at least one of the aromatic carbon atoms of the PTCDA radical and/or on at least one aromatic carbon atom of the radical R^{I}. Preferably, this means that a substitution by a group selected from alkyl, halogen, alkoxy, OH may be present on at least one of the aromatic carbon atoms of the PTCDA radical. “Aromatic carbon atoms of the PTCDA radical” are those aromatic carbon atoms in structural formula (I) which are not encompassed by the radical R^{I}.

The end group of the first repeat unit of the polymer P_{Redox} according to the invention, which is located in the chemical structure (I) at the bond defined by “(i)”, and the end group of the nth repeat unit of the polymer P_{Redox} according to the invention, which is located in the chemical structure (I) at the bond defined by “(ii)”, are not particularly restricted and result from the polymerization method used in the preparation method of the polymer according to the invention. Thus, these may be termination fragments of an initiator or of a repeat unit. Preferably, these end groups are selected from hydrogen, halogen, hydroxyl, unsubstituted or —CN, —OH, halogen-substituted aliphatic radical (which may, in particular, be an unsubstituted or correspondingly substituted alkyl group), (hetero)aromatic radical, which is preferably phenyl radical, benzyl radical or α-hydroxybenzyl. Most preferably, these end groups are hydrogen [in particular at the corresponding bond designated by “(i)”] or OH [in particular at the corresponding bond designated by “(ii)”].

### 4.2 Conductivity Additive L

### 4.2.1 Preferred Conductivity Additives L

The at least one conductivity additive L, which is comprised by the electrode material according to the first aspect of the invention, is at least one electrically conductive material, in particular selected from the group consisting of carbon materials, electrically conductive polymers, (semi)metals, (semi)metal compounds, preferably selected from the group consisting of carbon materials, electrically conductive polymers.

According to the invention, “(semi)metals” are selected from the group consisting of metals, semimetals, and are preferably metals. Metals are, in particular, selected from the group consisting of zinc, iron, copper, silver, gold, chromium, nickel, tin, and indium.

Semimetals are, in particular, selected from the group consisting of silicon, germanium, gallium, arsenic, antimony, selenium, tellurium, and polonium.

The at least one conductivity additive L is preferably a carbon material. Carbon materials are, in particular, selected from the group consisting of carbon fibers, carbon nanotubes (“CNT”), graphite, graphene, carbon black, and fullerene.

Electrically conductive polymers are, in particular, selected from the group consisting of polypyrroles, polyanilines, polyphenylenes, polypyrenes, polyalenenes, polynaphthylenes, polycarbazoles, polyindoles, polyazepines, polyphenylene sulfides, polythiophenes, polyacetylenes, poly(3,4-ethylenedioxythiophene)polystyrenesulfonate (=“PEDOT:PSS”), polyazenes, and poly-(p-phenylenevinylenes).

### 4.2.2 Preferred Amount of the Conductivity Additives L

The amount of the conductivity additive L comprised by the electrode material according to the first aspect of the invention is not further restricted. However, it is preferred that, in the electrode material according to the first aspect of the invention, the ratio of the total weight of all conductivity additives L based on the total weight of all organic redox-active polymers P_{Redox} is in the range from 0.1 to 1000%, in particular in the range from 1 to 500%, preferably in the range from 5 to 100%, more preferably in the range from 6 to 80%, even more preferably in the range from 7 to 60%, even more preferably in the range from 8 to 40%, even more preferably in the range from 10 to 35%, even more preferably in the range from 15 to 33%, most preferably in the range from 20 to 25%.

### 4.3 Optional Ionic Liquid IL₁

The electrode material according to the invention, optionally and preferably, also comprises at least one ionic liquid IL₁. The ionic liquid IL₁ has, in particular, a melting point 100° C., preferably 70° C., more preferably 50° C., even more preferably 20° C., most preferably in the range from −20° C. to 20° C.

### 4.3.1 Preferred Ionic Liquid IL₁

The ionic liquid IL₁ is not restricted and is described, for example, in WO 2004/016631 A1, WO 2006/134015 A1, US 2011/0247494 A1 or US 2008/0251759 A1.

In particular, the ionic liquid IL₁, which is optionally comprised by the electrode material according to the first aspect of the invention, has the structure Q⁺A⁻.

### 4.3.1.1 Preferred Cation Q⁺ of IL

Therein, Q⁺ is preferably a cation selected from the group consisting of the following structures (Q1), (Q2), (Q3), (Q4), (Q5) with

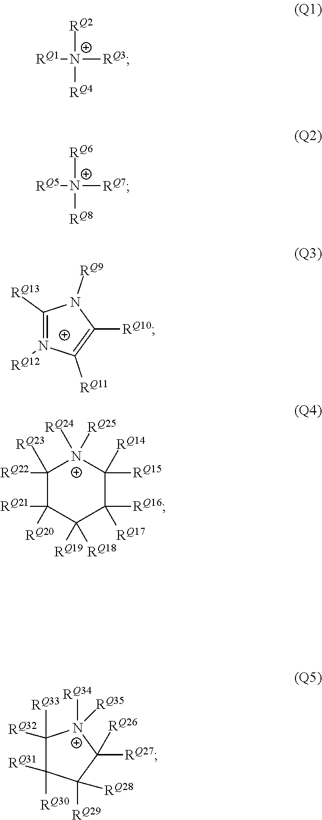

wherein R^{Q1}, R^{Q2}, R^{Q3}, R^{Q4}, R^{Q5}, R^{Q6}, R^{Q7}, R^{Q8} are each independently selected from the group consisting of an alkyl group, a haloalkyl group, and a cycloalkyl group, wherein R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q2}, R^{Q27}, R^{Q28}, R^{Q29}, R^{Q30}, R^{Q31}, R^{Q32}, R^{Q33}, R^{Q34}, R³⁵ are each independently selected from the group consisting of hydrogen, an alkyl group, a (poly)ether group, a haloalkyl group, and a cycloalkyl group.

More preferably, Q⁺ is a cation selected from the group consisting of the structures (Q1), (Q2), (Q3), (Q4), (Q5), wherein R^{Q1}, R^{Q2}, R^{Q3}, R^{Q4}, R^{Q5}, R^{Q6}, R^{Q7}, R^{Q8} are each independently selected from the group consisting of an alkyl group having 6 to 40, more preferably 10 to 30 carbon atoms, and a cycloalkyl group having 6 to 40, more preferably 10 to 30 carbon atoms,

wherein R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, R³⁵ are each independently selected from the group consisting of hydrogen, an alkyl group having 1 to 25, preferably 1 to 10 carbon atoms, and a (poly)ether group having 1 to 25, preferably 1 to 10 carbon atoms.

For the purposes of the invention, “(poly)ether group” means “polyether group or ether group”, preferably “polyether group”.

More preferably, Q⁺ is a cation selected from the group consisting of the structures (Q1), (Q3), wherein RQ1, RQ2, RQ3, RQ4 are each independently selected from the group consisting of an alkyl group having 6 to 30, preferably 10 to 25 carbon atoms,

and wherein R^{Q9}, R^{Q10}, R^{Q11}, R^{Q12}, R^{Q13} are each independently selected from the group consisting of hydrogen, an alkyl group having 1 to 25, preferably 1 to 10 carbon atoms, and even more preferably R^{Q10}, R^{Q11}, R^{Q13} are each hydrogen and R^{Q9}, R^{Q12} are each independently an alkyl radical having 1 to 6 carbon atoms.

Even more preferably, Q⁺ is a cation of the structure (Q3), wherein R^{Q10}, R^{Q11}, R^{Q13} are each hydrogen and R^{Q9} is selected from the group consisting of an alkyl group having 1 to 25, preferably 1 to 10 carbon atoms, more preferably methyl, ethyl, n-propyl, isopropyl, n-butyl, sec-butyl, tert-butyl, and R^{Q12} is selected from the group consisting of alkyl group having 1 to 25, preferably 1 to 10 carbon atoms, more preferably methyl, ethyl, n-propyl, isopropyl, n-butyl, sec-butyl, tert-butyl.

Even more preferably, Q⁺ is a cation of the structure (Q3), wherein R^{Q10}, R^{Q11}, R^{Q13} are each hydrogen and R^{Q9} is selected from the group consisting of methyl, ethyl, n-butyl, preferably from the group consisting of ethyl, n-butyl, wherein R^{Q9} is most preferably ethyl, and R^{Q12} is selected from the group consisting of methyl, ethyl, wherein R^{Q12} is most preferably methyl.

Particularly preferred as Q⁺ is the 1-ethyl-3-methylimidazolium cation.

### 4.3.1.2 Preferred Anion A⁻ of IL

In the aforementioned formula Q⁺A⁻, A⁻ is an anion which is, in particular, selected from the group consisting of phosphate, phosphonate, alkylphosphonate, monoalkylphosphate, dialkylphosphate, bis[trifluoromethanesulfonyl]imide, alkylsulfonate, haloalkylsulfonate, alkylsulfate, haloalkylsulfate, bis[fluorosulfonyl]imide, halide, dicyanamide, hexafluorophosphate, sulfate, tetrafluoroborate, trifluoromethanesulfonate, perchlorate, hydrogensulfate, haloalkylcarboxylate, alkylcarboxylate, formate, bisoxalatoborate, tetrachloroaluminate, dihydrogenphosphate, monoalkylhydrogenphosphate, and nitrate.

In the aforementioned formula Q⁺A⁻, A⁻ is more preferably selected from the group consisting of phosphate, phosphonate, alkylphosphonate, monoalkylphosphate, dialkylphosphate, bis[trifluoromethanesulfonyl]imide, alkylsulfonate, alkylsulfate, bis[fluorosulfonyl]imide, halide, dicyanamide, hexafluorophosphate, sulfate, tetrafluoroborate, trifluoromethanesulfonate, perchlorate, hydrogensulfate, alkylcarboxylate, formate, bisoxalatoborate, tetrachloroaluminate, dihydrogenphosphate, monoalkylhydrogenphosphate, nitrate, wherein the alkyl groups in alkylphosphonate, monoalkylphosphate, dialkylphosphate, alkylsulfonate, alkylsulfate, alkylcarboxylate, and monoalkylhydrogenphosphate, each having 1 to 10, preferably 1 to 6, even more preferably 1 to 4 carbon atoms.

In the aforementioned formula Q⁺A⁻, A⁻ is more preferably selected from the group consisting of dialkylphosphate, bis[trifluoromethanesulfonyl]imide, alkylsulfonate, alkylsulfate, bis[fluorosulfonyl]imide, chloride, dicyanamide, hexafluorophosphate, tetrafluoroborate, trifluoromethanesulfonate, perchlorate, acetate, propionate, formate, tetrachloroaluminate, monoalkylhydrogenphosphate, nitrate, wherein the alkyl groups in dialkylphosphate, alkylsulfonate, monoalkylhydrogenphosphate, each having 1 to 10, preferably 1 to 6, even more preferably 1 to 4 carbon atoms.

In the aforementioned formula Q⁺A⁻, A⁻ is even more preferably selected from the group consisting of diethylphosphate, bis[trifluoromethanesulfonyl]imide, methylsulfonate, methylsulfate, bis[fluorosulfonyl]imide, chloride, dicyanamide, hexafluorophosphate, tetrafluoroborate, trifluoromethanesulfonate, perchlorate, acetate, propionate, formate, tetrachloroaluminate, monoethylhydrogenphosphate, and nitrate.

In the aforementioned formula Q⁺A⁻, A⁻ is even more preferably selected from the group consisting of methylsulfonate, methylsulfate, trifluoromethanesulfonate, bis[trifluoromethanesulfonyl]imide, diethylphosphate, dicyanamide, most preferably from the group consisting of trifluoromethanesulfonate, and bis[trifluoromethanesulfonyl]imide.

A⁻ is most preferably trifluoromethanesulfonate.

### 4.3.2 Mass of the IL₁ Used

In the embodiments of the electrode material according to the first aspect of the invention in which the electrode material comprises an ionic liquid IL₁, the amount of the ionic liquid IL₁ comprised by the electrode material according to the first aspect of the invention is not further restricted.

However, in the embodiments in which the electrode material according to the invention comprises at least one ionic liquid IL₁, it is preferred that the ratio of the total weight of all ionic liquids IL₁ comprised by the electrode material based on the total weight of all organic redox-active polymers P_{Redox} comprised by the electrode material is in the range from 0.1 to 1000%, in particular in the range from 1 to 500%, preferably in the range from 1 to 100%, more preferably in the range from 5 to 80%, even more preferably in the range from 10 to 70%, even more preferably in the range from 15 to 60%, even more preferably in the range from 20 to 50%, even more preferably in the range from 20 to 45%, even more preferably in the range from 25 to 40%, most preferably in the range from 27 to 32%.

### 4.4 Cellulose Ether C

The electrode material according to the invention comprises at least one cellulose ether C. This has the function of a binder (also referred to as “binder additive”).

The cellulose ether C is preferably characterized in that it comprises m repeat units of the following structural formula (II):

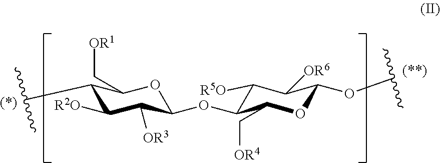

wherein the radicals R¹, R², R³, R⁴, R⁵, R⁶ are selected from the group consisting of hydrogen, alkyl, hydroxyalkyl, carboxyalkyl, in particular from the group consisting of hydrogen, hydroxyalkyl, carboxyalkyl, preferably from the group consisting of hydrogen, carboxyalkyl, more preferably from the group consisting of hydrogen, and carboxymethyl,
wherein in at least one of the repeat units of the structural formula (II) comprised by the cellulose ether C at least one of the radicals R¹, R², R³, R⁴, R⁵, R⁶ is different from hydrogen, in particular in at least 1%, preferably in at least 5%, more preferably in at least 10%, even more preferably in at least 20%, even more preferably in at least 30%, even more preferably in at least 40%, even more preferably in at least 50%, even more preferably in at least 60%, even more preferably in at least 70%, even more preferably in at least 80%, even more preferably in at least 90% of all repeat units of the structural formula (II) comprised by the cellulose ether C, wherein at least one of the radicals R¹, R², R³, R⁴, R⁵, R⁶ is different from hydrogen,
and wherein m is an integer 2, in particular an integer 4, preferably an integer 100, more preferably an integer in the range from 100 to 109, even more preferably an integer in the range from 100 to 10⁶, even more preferably an integer in the range from 100 to 10⁴, most preferably an integer in the range from 100 to 2000,
and wherein the bond characterized by “(*)” of a repeat unit of the structural formula (II) bonds to the bond characterized by “(**)” of the adjacent repeat unit of the structural formula (II),
and the repeat units of the structural formula (II) comprised by the cellulose ether C are identical to or different from one another.

In a preferred embodiment, the cellulose ether C is selected from the group consisting of carboxymethylcellulose, methylcellulose, ethylcellulose, hydroxyethylcellulose, hydroxypropylcellulose, methylethylcellulose, hydroxyethylmethylcellulose, hydroxypropylmethylcellulose, ethylhydroxyethylcellulose, and carboxymethylhydroxyethylcellulose, and is preferably carboxymethylcellulose. Carboxymethylcellulose is preferably present in the form of its sodium salt.

“Carboxymethylcellulose” is a particular embodiment of the cellulose ether C, which is characterized in that the radicals R¹, R², R³, R⁴, R⁵, R⁶ are selected from the group consisting of hydrogen, and carboxymethyl.

For the purposes of the invention, the expression “carboxy” denotes both the protonated and the deprotonated form of a —COOH function. The deprotonated form “—COO⁻” is present here, in particular, as a salt, preferably as an alkali metal salt, more preferably as a sodium salt.

Accordingly, for the purposes of the invention, “carboxyalkyl” denotes both an alkyl group having a “—COOH” group and an alkyl group having a “—COO⁻” group. The “—CH2-COO⁻” group is present here in particular as a salt, preferably as an alkali metal salt, more preferably as a sodium salt (“—COONa”).

Accordingly, for the purposes of the invention, “carboxymethyl” denotes both the structure “—CH₂—COOH” and “—CH2-COO⁻”. The “—CH2-COO⁻” group is present here in particular as an alkali metal salt, more preferably as a sodium salt: “—CH₂—COONa”. Accordingly, for the purposes of the invention, “carboxymethylcellulose” may be present both in the acid form (e.g. CAS No.: 9000-11-7) and as a sodium salt (e.g. CAS No.: 9004-32-4). Preference is given to the sodium salt.

Methylcellulose is a particular embodiment of the cellulose ether C, which is characterized in that the radicals R¹, R², R³, R⁴, R⁵, R⁶ are selected from the group consisting of hydrogen, methyl. The CAS No. of methylcellulose is, in particular, 99638-59-2.

Ethylcellulose is a particular embodiment of the cellulose ether C, which is characterized in that the radicals R¹, R², R³, R⁴, R⁵, R⁶ are selected from the group consisting of hydrogen, ethyl. The CAS No. of ethylcellulose is, in particular, 9004-57-3.

Hydroxyethylcellulose is a particular embodiment of the cellulose ether C, which is characterized in that the radicals R¹, R², R³, R⁴, R⁵, R⁶ are selected from the group consisting of hydrogen, 2-hydroxyethyl. The CAS No. of hydroxyethylcellulose is, in particular, 9004-62-0.

Hydroxypropylcellulose is a particular embodiment of the cellulose ether C, which is characterized in that the radicals R¹, R², R³, R⁴, R⁵, R⁶ are selected from the group consisting of hydrogen, 2-hydroxy-n-propyl. The CAS No. of hydroxypropylcellulose is, in particular, 9004-64-2.

Methylethylcellulose is a particular embodiment of the cellulose ether C, which is characterized in that the radicals R¹, R², R³, R⁴, R⁵, R⁶ are selected from the group consisting of hydrogen, methyl, ethyl. The CAS No. of methylethylcellulose is, in particular, 9004-69-7.

Hydroxyethylmethylcellulose is a particular embodiment of the cellulose ether C, which is characterized in that the radicals R¹, R², R³, R⁴, R⁵, R⁶ are selected from the group consisting of hydrogen, methyl, 2-hydroxyethyl. The CAS No. of hydroxyethylmethylcellulose is, in particular, 9032-42-2.

Hydroxypropylmethylcellulose is a particular embodiment of the cellulose ether C, which is characterized in that the radicals R¹, R², R³, R⁴, R⁵, R⁶ are selected from the group consisting of hydrogen, methyl, 2-hydroxypropyl. The CAS No. of hydroxypropylmethylcellulose is, in particular, 9004-65-3.

Ethylhydroxyethylcellulose is a particular embodiment of the cellulose ether C, which is characterized in that the radicals R¹, R², R³, R⁴, R⁵, R⁶ are selected from the group consisting of hydrogen, ethyl, 2-hydroxyethyl. The CAS No. of ethylhydroxyethylcellulose is, in particular, 9004-58-4.

Carboxymethylhydroxyethylcellulose is a particular embodiment of the cellulose ether C, which is characterized in that the radicals R¹, R², R³, R⁴, R⁵, R⁶ are selected from the group consisting of hydrogen, carboxymethyl, 2-hydroxyethyl. The CAS No. of carboxymethylhydroxyethylcellulose is, in particular, 9088-04-4.

Carboxymethylcellulose is the most preferred cellulose ether C.

It is preferred that the ratio of the total weight of all cellulose ethers C comprised by the electrode material according to the first aspect of the invention based on the total weight of all organic redox-active polymers P_{Redox} comprised by the electrode material according to the invention is in the range from 0.001 to 100%, more preferably in the range from 0.1 to 90%, even more preferably in the range from 3 to 70%, even more preferably in the range from 4 to 50%, even more preferably in the range from 4 to 20%, even more preferably in the range from 4 to 15%, and most preferably 7 to 12%.

The degree of etherification ζ averaged over all cellulose ethers C comprised by the electrode material (also termed “average degree of etherification” or “average degree of substitution”) is here, in particular, in the range from 1 to 100%, preferably in the range from 10 to 99%, more preferably in the range from 15 to 98%, even more preferably in the range from 36 to 97%, even more preferably in the range from 40 to 96%, even more preferably in the range from 50 to 95%, even more preferably in the range from 60 to 95%, even more preferably in the range from 65 to 90%, even more preferably in the range from 70 to 85%.

For the purposes of the invention, the average degree of etherification ζ denotes the proportion of the radicals R¹ to R⁶ in all repeat units of the formula (II) comprised by the electrode material according to the invention which are comprised by the cellulose ethers C in the electrode material which are different from hydrogen, based on the total number of all radicals R¹ to R⁶ in all repeat units of the formula (II) comprised by the electrode material according to the invention which are comprised by the cellulose ethers C in the electrode material.

The average degree of etherification ζ can be determined by methods familiar to the person skilled in the art, in particular by NMR or (in the case of sodium carboxymethylcellulose) by near-infrared spectroscopy (“NIR”; described in the NIR Application Note NIR-31, available at https://www.metrohm.com/de-de/applications/AN-NIR-031) or by determining the sodium content as described in RESOLUTION OIV/OENO 366/2009 (Federico CASTELLUCCI, 2009, point 5.17; available at https://www.oiv.int/public/medias/1192/oiv-oeno-366-2009-de.pdf). Particularly preferred are NMR-based methods.

The end group of the first repeat unit of the cellulose ether C according to the invention, which is located in the chemical structure (II) at the bond defined by “(*)”, and the end group of the mth repeat unit of the cellulose ether C according to the invention, which is located in the chemical structure (II) at the bond defined by (**), are not particularly restricted and result from the method used in the preparation method or recovery of the cellulose ether C. Preferably, these end groups are selected from hydrogen, hydroxyl, unsubstituted or —CN, —OH, halogen-substituted aliphatic radical (which may, in particular, be an unsubstituted or correspondingly substituted alkyl group). Most preferably, these end groups are hydrogen [in particular for the bond designated by “(**)”] and OH [in particular for the bond designated by (*)].

### 4.5 Solvent

The electrode material according to the first aspect of the invention comprises, in particular, water.

The electrode material according to the first aspect of the invention is present, in particular, as a, preferably aqueous, electrode slurry.

In addition, the electrode material may comprise, as an alternative or in addition to water, at least one organic solvent which differs from IL₁.

Organic solvents which are particularly suitable according to the invention preferably have a boiling point at atmospheric pressure of 50° C. to 250° C., preferably 55° C. to 150° C.

Organic solvents which are particularly suitable according to the invention are, in particular, selected from the group consisting of alcohols, ethers, ketones, esters, preferably selected from the group consisting of alcohols, ketones, esters, more preferably selected from the group of alcohols.

Alcohols which are particularly suitable according to the invention are preferably selected from the group consisting of glycol, methanol, n-butanol, 2-ethylhexanol, isobutanol, isopropanol, n-pentanol, n-propanol, 2-methylbutanol, diisobutylcarbinol, ethanol and more preferably selected from the group consisting of glycol, methanol, isopropanol, n-propanol, ethanol.

Esters which are particularly suitable according to the invention are preferably selected from the group consisting of n-butyl acetate, propylene glycol diacetate, n-amyl acetate, isoamyl acetate, isopropyl acetate, isobutyl acetate, n-propyl acetate, n-butyl propionate, n-pentyl propionate, and n-propyl propionate.

Ethers which are particularly suitable according to the invention are, in particular glycol ethers which are preferably selected from the group consisting of propylene glycol methyl ether, dipropylene glycol methyl ether, tripropylene glycol methyl ether, propylene glycol methyl ether acetate, dipropylene glycol methyl ether acetate, propylene glycol n-propyl ether, dipropylene glycol n-propyl ether, propylene glycol n-butyl ether, dipropylene glycol n-butyl ether, propylene glycol phenyl ether, dipropylene glycol phenyl ether, propylene glycol diacetate, bisdipropylene glycol n-butyl ether acetate, dipropylene glycol dimethyl ether, diethylene glycol methyl ether, triethylene glycol methyl ether, diethylene glycol ethyl ether, triethylene glycol ethyl ether, ethylene glycol propyl ether, ethylene glycol n-butyl ether, diethylene glycol n-butyl ether, triethylene glycol n-butyl ether, ethylene glycol n-butyl ether acetate, diethylene glycol n-butyl ether acetate, ethylene glycol hexyl ether, diethylene glycol hexyl ether, ethylene glycol phenyl ether, diethylene glycol phenyl ether, α-phenyl-ω-hydroxy-poly(oxy-1,2-ethanediyl), and ethylene glycol phenyl ether.

Ketones which are particularly suitable according to the invention are preferably selected from the group consisting of acetone, methyl ethyl ketone, methyl isobutyl ketone, and butyl ketone.

In a further preferred embodiment of the present invention, the electrode material according to the first aspect of the invention comprises a solvent which is a mixture of water and at least one organic solvent.

If the electrode material according to the first aspect of the invention is used as an electrode slurry, the concentration of the organic redox-active polymer P_{Redox} according to the invention in the electrode slurry is preferably between 1 and 1000 mg/ml, preferably 30 and 500 mg/ml, more preferably 50 and 300 mg/ml, particularly preferably 60 and 250 mg/ml.

### 4.6 Electrode

The present invention relates in a second aspect to an electrode (different word “electrode element”) comprising the electrode material according to the first aspect of the invention and a substrate.

The substrate of the electrode element comprises, in particular, at least one selected from the group consisting of conductive materials, preferably metals, carbon materials, oxide substances, and conductive polymers. The substrate preferably comprises non-conductive materials to which these conductive materials are applied. These non-conductive materials are, in particular, non-conductive polymers or cellulose compounds.

Preferred conductive polymers are selected from the group consisting of polypyrroles, polyanilines, polyphenylenes, polypyrenes, polyalenes, polynaphthylenes, polycarbazoles, polyindoles, polyazepines, polyphenylene sulfides, polythiophenes, polyacetylenes, poly(3,4-ethylenedioxythiophene)polystyrenesulfonate (=PEDOT:PSS), and polyazenes, poly-(p-phenylenevinylenes).

Preferred non-conductive polymers are selected from the group consisting of polyethylene, polyethylene terephthalate (=PET), polyurethane, polyester, polypropylene, polyimides, and epoxy resins.

Preferred cellulose compounds are cellulose, cardboard, and paper.

Metals which are preferably suitable as substrate of the electrode element are selected from platinum, gold, iron, copper, aluminum, zinc, silver or a combination of these metals. These metals may also be present as mixtures with carbon, such as silver/carbon conductors.

Carbon materials which are preferably suitable as substrate of the electrode element are selected from vitreous carbon, graphite foil, graphene, and carbon sheets.

Oxide substances which are preferably suitable as substrate of the electrode element are selected from the group consisting of indium tin oxide (ITO), indium zinc oxide (IZO), aluminum zinc oxide (AZO), fluorotin oxide (FTO), aluminum tin oxide (ATO), and zinc oxide (ZO).

The surface layer of the electrode element comprises at least the electrode material according to the invention according to the first aspect of the invention as redox-active material for charge storage.

The electrode material according to the first aspect of the invention is applied, in particular, as electrode slurry to the substrate of the electrode element. The electrode slurry is, in particular, a solution or suspension and preferably comprises the electrode material according to the invention and water, as described under section 4.5.

An electrode element has at least partially a layer on a substrate surface in the embodiment in which the electrode material according to the invention is formed as an at least partial surface coating of electrode elements for electrical charge storage elements, in particular secondary batteries. This layer comprises, in particular, the electrode material according to the first aspect of the invention.

The application of the electrode material according to the invention according to the first aspect of the invention to the substrate is possible with the aid of methods known to the person skilled in the art. In particular, the electrode material according to the first aspect of the invention is applied as electrode slurry to the substrate by means of squeegee coating, slot die coating, rolling, spraying, screen printing, gravure printing, pad printing, flexographic printing, or stencil printing.

### 4.7 Charge Storage Elements

The present invention relates in a third aspect to a charge storage unit, in particular a secondary battery, comprising at least one electrode according to the second aspect of the invention.

In general, redox-active electrode materials for storing electrical energy are materials which can store and release electrical charge again, for example, by taking up or releasing electrons. Accordingly, the electrode material according to the invention can be used, for example, as active electrode material in an electrical charge storage element. Such electrical charge storage elements for storing electrical energy are selected, in particular, from the group consisting of primary batteries, secondary batteries (also referred to as “accumulators”), redox flow batteries, supercapacitors.

Preferably, the electrical charge storage element according to the third aspect of the invention is a primary or secondary battery, more preferably a secondary battery. The charge storage element according to the third aspect of the invention, preferably the battery, comprises in a preferred embodiment at least one electrode according to the invention according to the first aspect of the invention, at least one electrolyte and, optionally, a separator.

The main object of the electrolyte is to ensure the ionic conductivity which is necessary for charge equalization. The electrolyte of the, preferably secondary, battery comprises a liquid and, optionally, also an oligomeric or polymeric compound having high ionic conductivity (“gel electrolyte” or “solid state electrolyte”), as described, for example, in WO 2020/126200 A1. The electrolyte preferably comprises an oligomeric or polymeric compound.

The liquid acting as electrolyte is composed, in particular, of one or more solvents and one or more conductive salts. In these cases, the electrolyte may comprise at least one ionic liquid IL₂.

In a preferred embodiment the charge storage element according to the third aspect of the invention is metal-free. In this preferred embodiment it is even more preferred to use ionic liquids as conductive salts.

If ionic liquids are used in the charge storage element according to the third aspect of the invention, they can be used both as solvent of the electrolyte, as conductive salt, but also as complete electrolyte.

The charge storage element comprises an ionic liquid IL₂ as electrolyte in a preferred embodiment of the charge storage unit according to the third aspect of the invention. IL₂ preferably has the aforementioned structure Q⁺A⁻, wherein Q⁺ is, in particular, as described under section 4.3.1.1 and A⁻ is, in particular, as described under section 4.3.1.2. In the charge storage element according to the third aspect of the invention IL₂ is even more preferably the same ionic liquid as is present as IL₁ in at least one electrode according to the first aspect of the invention comprised by the charge storage element according to the third aspect of the invention.

The separator is a porous layer which is ion-permeable and enables charge equalization. The object of the separator is to separate the positive electrode from the negative electrode and to enable charge equalization by permeation of ions. As separator of the charge storage elements, preferably of the secondary battery, use is made, in particular, of a porous material (e.g. nonwoven), preferably a membrane consisting of a polymeric compound, such as, for example, polyolefin, polyamide, or polyester. Furthermore, separators made of porous ceramic materials, glass microfiber, can be used.

Separator and electrolyte may also be present in one, such as, for example, in the case of the solid electrolytes, described in WO 2020/126200 A1.

### 4.8 Use of the Electrode Material According to the Invention

In a fourth aspect, the present invention relates to the use of the electrode material according to the invention as an ink in printing processes, in particular with squeegee coating, slot die coating, rolling, spraying, screen printing, gravure printing, pad printing, flexographic printing, or stencil printing. Preferred printing processes here are gravure printing or screen printing.

### 4.9 Result

As shown in the examples, a polyimide according to the invention (according to the examples that of the structural formula 3) in combination with cellulose ether binders C, in particular carboxymethylcellulose, provides electrode materials which stand out for a high capacity even after several charging/discharging cycles (=cycling resistance). Other, structurally similar polyimides, based on PMDA, NTCDA units (structures 1 and 2 according to examples), do not result in such good results in combination with cellulose ether binders. Polyimides according to the invention are thus surprisingly suitable in combination with cellulose ether binders as electrode materials for electrodes which ensure a high charging/discharging capacity over a large number of charging/discharging cycles.

### 5. EXAMPLES

### 5.1 General

Pyromellitic dianhydride (“PMDA”, CAS number: 89-32-7) was obtained from TCI Chemical Industrie.

1,4,5,8-Naphthalenetetracarboxylic dianhydride (“NTCDA”, CAS number: 81-30-1) was obtained from TCI Chemical Industrie.

3,4,9,10-Perylenetetracarboxylic dianhydride (“PTCDA”, CAS number: 128-69-8) was obtained from CHEMOS GmbH & Co. KG.

A 5% strength by weight dispersion of multiwall carbon nanotubes in N-methyl-2-pyrrolidone was used as conductive additive (“Orgacyl 502” from Nanocyl).

Carbon black (“Super P” from Timcal) was used as conductive additive.

MAC500 LC from Nippon Paper was used as carboxymethylcellulose sodium salt (“NaCMC”; CAS number: 9004-32-4).

1-Ethyl-3-methylimidazolium triflate (“EMIMOTf”) from io-li-tec was used as ionic liquid.

1,2-Ethylenediamine (“EDA”, CAS No. 107-15-3) was obtained from Sigma-Aldrich.

### 5.2 Synthesis of Various Polyimides

### 5.2.1 Synthesis of PMDA-EDA-Orgacyl 1.

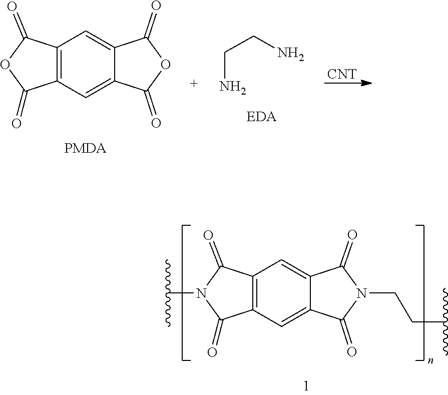

Pyromellitic dianhydride (“PMDA”, 17.45 g, 80.00 mmol) and Orgacyl 502 (22.16 g, 5% by weight in N-methyl-2-pyrrolidone) were suspended in dry N,N-dimethylformamide (“DMF”, 700 ml) by means of ultrasound under an argon atmosphere. 1,2-Ethylenediamine (“EDA”, 4.81 g, 80.00 mmol) was then added and the mixture was stirred at room temperature for 4 h. The suspension was then heated to 153° C. and stirred for a further 4 h. The reaction mixture was cooled to room temperature and the residue was filtered off after the reaction had ended. The residue was washed with DMF/acetone (v/v=1/1), acetone and water and dried in vacuum. 21.00 g of 1 were obtained as a black solid.

### 5.2.2 Synthesis of NTCDA-EDA-Orgacyl 2

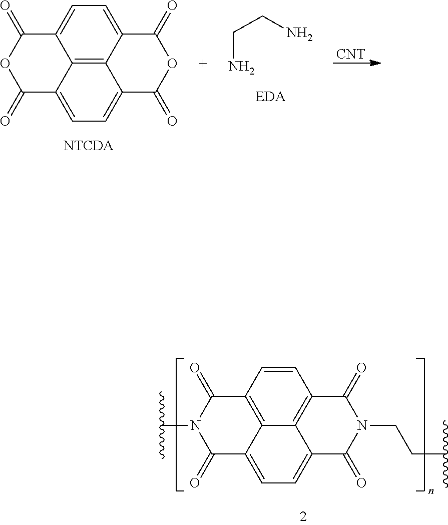

1,4,5,8-Naphthalenetetracarboxylic dianhydride (“NTCDA”, 22.12 g, 80.00 mmol, 97% by weight) and Orgacyl 502 (28.09 g, 5% by weight in N-methyl-2-pyrrolidone) were suspended in 700 ml of dry DMF by means of ultrasound under an argon atmosphere. 1,2-Ethylenediamine (“EDA”, 4.81 g, 80.00 mmol) was then added and the mixture was stirred at room temperature for 4 h. The suspension was then heated to 153° C. and stirred for a further 4 h. The reaction mixture was cooled to room temperature and the residue was filtered off after the reaction had ended. The residue was washed with DMF/acetone (v/v=1/1), acetone and water and dried in vacuum. 25.45 g of 2 were obtained as a grey solid.

### 5.2.3 Synthesis of PTCDA-EDA-Orgacyl 3

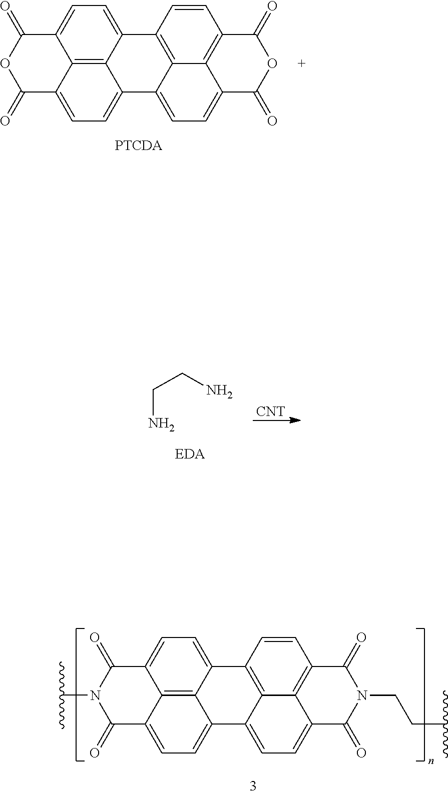

3,4,9,10-Perylenetetracarboxylic dianhydride (“PTCDA”, 31.39 g, 80.00 mmol) and Orgacyl 502 (39.86 g, 5% by weight in N-methyl-2-pyrrolidone) were suspended in 700 ml of dry DMF by means of ultrasound under an argon atmosphere. 1,2-Ethylenediamine (“EDA”, 4.81 g, 80.00 mmol) was then added and the mixture was stirred at room temperature for 4 h. The suspension was then heated to 153° C. and stirred for a further 4 h. The reaction mixture was cooled to room temperature and the residue was filtered off after the reaction had ended. The residue was washed with DMF/acetone (v/v=1/1), acetone and water and dried in vacuum. 36.42 g of 3 were obtained as a black solid.

### 5.3 Production of Electrodes

5.3.1 Comparative Example V1 Production of an Anode with PMDA-EDA-Orgacyl 1

19.98 g of a 1.6% strength NaCMC solution (sodium carboxymethylcellulose, 319.7 mg) and EMIM OTf (1-ethyl-3-methylimidazolium trifluoromethanesulfonate, 1.03 g) were dispersed by means of grinding beads (ZrO2, diameter 1.25-1.6 mm, 42 g) in a dissolver. Polymer 1 (3.79 g) was then added and the mixture was stirred for 1 h. Super P (0.46 g) and water (0.84 g) were then added and the mixture was dispersed for a further hour. The grinding beads were removed, and the resulting electrode paste was applied to aluminum foil and dried in a circulating air-drying cabinet. The proportion of the active material on the electrodes was determined on the basis of the masses of dried electrodes.

5.3.2 Comparative Example V2 Production of an Anode with NTCDA-EDA-Orgacyl 2

Comparative example V1 was repeated, except that the same amount (3.79 g) of polymer 2 was used instead of 3.79 g of polymer 1.

5.3.3 Inventive Example E1 Production of an Anode with PTCDA-EDA-Orgacyl 3

Comparative example V1 was repeated, except that the same amount (3.79 g) of polymer 3 was used instead of 3.79 g of polymer 1.

### 5.4 Production of Button Cells

Suitable electrodes were punched out of the coated foils prepared in examples V1, V2 and E1 (diameter 16 mm) and dried.

The button cells (type 2032) were constructed under an argon atmosphere. A stainless steel weight (diameter: 15.5 mm, thickness: 0.5 mm) and then lithium as standard (diameter: 16 mm, 99.9% by weight) were first placed in the anode cover. Whatman GF/A separator (diameter: 17 mm) which was wetted with LP47 (1 M LiPF₆ in ethylene carbonate:diethyl carbonate=3:7) was positioned on the lithium.

Subsequently, the electrodes produced and punched out in examples V1, V2 and E1 were aligned on the separator and weighted with a stainless steel weight (diameter: 15.5 mm, thickness: 0.5 mm) and a stainless steel spring (diameter: 14.5 mm, thickness: 0.3 mm). The button cell with the cathode housing was then closed by means of a pneumatic hand press.

### 5.5 Measurement of the Capacity of the Full Cells

The capacities of the cells constructed under point 5.4 were measured as follows: Each cell was subjected to 150 charging and discharging cycles with various charging rates of 1, 2 and 5 C.

1 C means full charging in one hour. 2 C means full charging in ½ hour and 5 C means full charging in ⅕ hour, i.e. 12 min.

The charging and discharging capacities were measured on a Maccor battery cycler. The respective currents were calculated in accordance with the active masses of the limiting electrode. The charging and discharging cycles were measured galvanostatically (DC), which means that cycling was carried out up to a termination voltage with constant current. The various half-cells were cycled between 1.3 and 3 V.

### 5.6 Results

The charging and discharging capacities of the respective cells, which were measured as described under point 5.5, are shown in figures 1 (charging rate 1 C), 2 (charging rate 2 C) and 3 (charging rate 5 C).

The x-axis of the respective figure indicates the respective charging cycle, the y-axis the capacitance in mAh g⁻¹.

It was found that the capacity of the cell whose anode comprised by the polyimide PTCDA-EDA-Orgacyl of structural formula 3 as redox-active polymer constantly shows the highest capacity value at the latest from the ^{˜}45th charging/discharging cycle compared to the cells whose anodes comprised the polyimide PMDA-EDA-Orgacyl of structural formula 1 and the polyimide NTCDA-EDA-Orgacyl of structural formula 2, respectively. The value of the capacity at a charging rate of 5 C was even higher from the first charging cycle onward over all subsequent charging cycles compared to the respective value measured in the comparative examples.

1. An electrode material, comprising:
(i) at least one organic redox-active polymer P_{Redox},
(ii) at least one conductivity additive L,
(iii) at least one cellulose ether C,
(iv) optionally at least one ionic liquid IL₁,
wherein the organic redox-active polymer P_{Redox} is a polyimide which comprises n repeat units of formula (I): 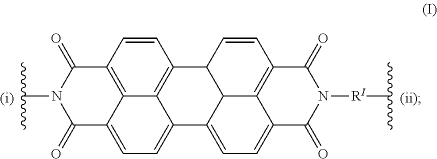
wherein R^{I} is selected from the group consisting of a direct bond, a carbonyl group, an alkylene group, a divalent aromatic hydrocarbon group, an alkylene group having at least one carbonyl group or one ether group, and at least two phenylene radicals linked to one another via an oxygen atom, and
wherein n is an integer≥2, and
wherein in formula (I) at least one aromatic carbon atom may be substituted by a group selected from the group consisting of alkyl, halogen, alkoxy, and OH, and
wherein the bond characterized by “(i)” of a repeat unit of formula (I) bonds to a bond characterized by “(ii)” of an adjacent repeat unit of formula (I), and
the repeat units of the structural formula (I) comprised by the polymer P_{Redox} are identical to or different from one another.

2. The electrode material according to claim 1, wherein the cellulose ether C comprises m repeat units of formula (II): 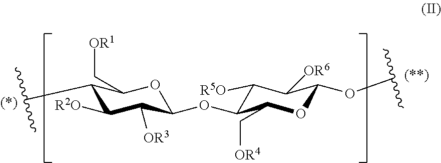
wherein the radicals R¹, R², R³, R⁴, R⁵, R⁶ are selected from the group consisting of hydrogen, alkyl, hydroxyalkyl, and carboxyalkyl,
wherein in at least one of the repeat units of formula (II) comprised by the cellulose ether C at least one of the radicals R¹, R², R³, R⁴, R⁵, R⁶ is different from hydrogen, and
wherein m is an integer≥2, and
wherein the bond characterized by “(*)” of a repeat unit of the structural formula (II) bonds to the bond characterized by “(**)” of an adjacent repeat unit of the structural formula (II),
and the repeat units of the structural formula (II) comprised by the cellulose ether C are identical to or different from one another.

3. The electrode material according to claim 2, wherein a degree of etherification ζ averaged over all cellulose ethers C comprised by the electrode material is in a range from 1 to 99%.

4. The electrode material according to claim 1, wherein R^{I} is an alkylene group.

5. The electrode material according to claim 1, wherein a ratio of a total weight of all cellulose ethers C comprised by the electrode material to a total weight of all organic redox-active polymers P_{Redox} comprised by the electrode material is in a range from 0.001 to 100%.

6. The electrode material according to claim 1, wherein the at least one conductivity additive L is selected from the group consisting of carbon materials, electrically conductive polymers, metals, semimetals, semimetal compounds, and metal compounds.

7. The electrode material according to claim 1, wherein a ratio of a total weight of all conductivity additives L based on a total weight of all organic redox-active polymers P_{Redox} is in a range from 0.1 to 1000%.

8. The electrode material according to claim 1, comprising:
at least one ionic liquid IL₁.

9. The electrode material according to claim 8, wherein the ionic liquid IL₁ has the structure Q⁺A⁻, wherein Q⁺ is a cation selected from the group consisting of (Q1), (Q2), (Q3), (Q4), and (Q5): 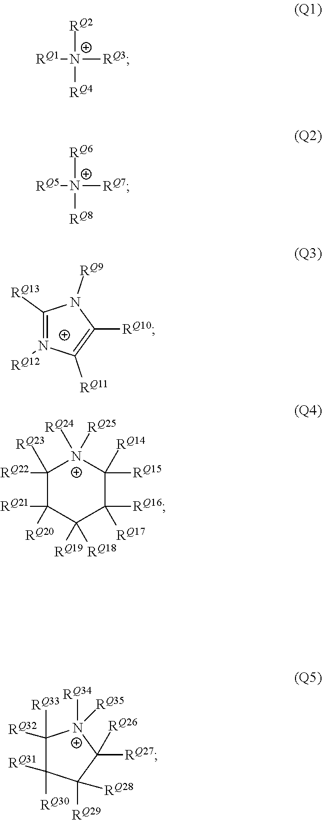
wherein R^{Q1}, R^{Q2}, R^{Q3}, R^{Q4}, R^{Q5}, R^{Q6}, R^{Q7}, and R^{Q8} are each independently selected from the group consisting of an alkyl group, a haloalkyl group, and a cycloalkyl group,
wherein R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, and R^{Q35} are each independently selected from the group consisting of hydrogen, an alkyl group, an ether group, a polyether group, a haloalkyl group, and a cycloalkyl group, and
wherein A⁻ is an anion.

10. The electrode material according to claim 8, wherein the ionic liquid IL₁ has a melting point≤100° C.

11. The electrode material according to claim 8, wherein a ratio of a total weight of all ionic liquids IL₁ comprised by the electrode material based on a total weight of all organic redox-active polymers P_{Redox} comprised by the electrode material is in a range from 0.1 to 1000%.

12. The electrode material according to claim 1, further comprising water.

13. An electrode, comprising:
an electrode material, comprising:
(i) at least one organic redox-active polymer P_{Redox},
(ii) at least one conductivity additive L,
(iii) at least one cellulose ether C,
(iv) optionally at least one ionic liquid IL₁,
wherein the organic redox-active polymer P_{Redox} is a polyimide which comprises n repeat units of formula (I): 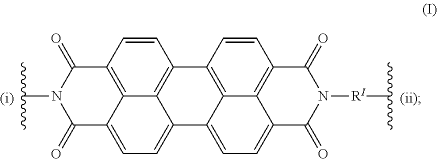
wherein R^{I} is selected from the group consisting of a direct bond, a carbonyl group, an alkylene group, a divalent aromatic hydrocarbon group, an alkylene group having at least one of one carbonyl group or one ether group, and at least two phenylene radicals linked to one another via an oxygen atom, and
wherein n is an integer≥2, and
wherein in formula (I) at least one aromatic carbon atom may be substituted by at least one group selected from the group consisting of alkyl, halogen, alkoxy, and OH, and
wherein the bond characterized by “(i)” of a repeat unit of formula (I) bonds to a bond characterized by “(ii)” of an adjacent repeat unit of formula (I), and
the repeat units of formula (I) comprised by the polymer P_{Redox} are identical to or different from one another, and
wherein the electrode further comprises a substrate.

14. A charge storage element, comprising:
at least one electrode comprising an electrode material comprising
(i) at least one organic redox-active polymer P_{Redox},
(ii) at least one conductivity additive L,
(iii) at least one cellulose ether C,
(iv) optionally at least one ionic liquid IL₁,
wherein the organic redox-active polymer P_{Redox} is a polyimide which comprises n repeat units of formula (I): 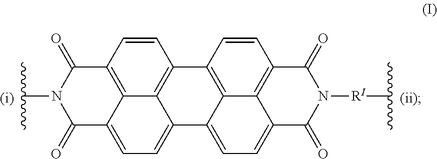
wherein R^{I} is selected from the group consisting of a direct bond, a carbonyl group, an alkylene group, a divalent aromatic hydrocarbon group, an alkylene group having at least one of one carbonyl group or one ether group, and at least two phenylene radicals linked to one another via an oxygen atom, and
wherein n is an integer≥2, and
wherein in formula (I) at least one aromatic carbon atom may be substituted by a group selected from the group consisting of alkyl, halogen, alkoxy, and OH, and
wherein a bond characterized by “(i)” of a repeat unit of formula (I) bonds to a bond characterized by “(ii)” of an adjacent repeat unit of formula (I), and
the repeat units of formula (I) comprised by the polymer P_{Redox} are identical to or different from one another, and
wherein the electrode further comprises a substrate.

15. The charge storage element according to claim 14, comprising:
at least one electrolyte comprising at least one ionic liquid IL₂.
